(19) United States
(12) Patent Application Publication
(10) Pub. No.: US 2009/0010107 A1
(43) Pub. Date: Jan. 8, 2009

(54) TAMPER-RESISTANT TIME REFERENCE AND APPARATUS USING SAME

(75) Inventor: Stefan Drude, Waalre (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/814,277

(22) PCT Filed: Jan. 16, 2006
(86) PCT No.: PCT/IB2006/050149

§ 371 Date: Aug. 14, 2008

Related U.S. Application Data
(60) Provisional application No. 60/644,541, filed on Jan. 18, 2005.

(51) Int. Cl. G04F 5/16

(52) U.S. Cl. 368/62

(57) ABSTRACT

A tamper-proof reference usable as a time reference and an integrated circuit apparatus using the tamper-proof reference to determine an elapsed time are disclosed. The circuit comprises a reference source (200) contained in an integrated package comprising a radioactive material (210), a measurement circuit (220) in contact with the radioactive material (210), the measurement circuit for collecting for a predetermined period radiation generated by the radioactive material (210) and a processor (110) in communication with the reference (200), the processor (110) for initiating a measurement by the reference (200) and for determining an elapsed time based on a plurality of measurements by the reference (200).

This application is related to the field of integrated circuits and, more particularly, to a method and apparatus for providing a tamper-resistant time reference.

In the context of digital-rights management, security and access control, there is a need for a method to grant rights to revive digital content for a limited period. A typical example, where the right or license to view digital content is relevant, is when renting a digital movie over the Internet. In this case, the right or license to view the movie is granted for a limited time, e.g., 24 hours.

However, conventional time mechanisms, which are based on a digital clock circuit, that determine the start and expiration of the grant period can easily be manipulated. For example, power may be removed from the timing mechanism and, hence, stop the timing. Another example is to reset the current time to a period within the grant time period. In either case, the user is able to extend the time beyond the allowed time to view the digital content.

Hence, there is a need in the industry for an apparatus to provide a tamper-resistant time reference.

A tamper-proof reference usable as a time reference and an integrated circuit apparatus using the tamper-proof reference to determine an elapsed time are disclosed. The apparatus comprises a reference source (200) comprising a radioactive material (210), a measurement circuit (220) in contact with the radioactive material (210), the measurement circuit for collecting for a predetermined period radiation generated by the radioactive material (210) and a processor (110) in communication with the reference (200), the processor (110) initiating a measurement by the reference (200) and determining an elapsed time based on a plurality of measurements obtained by the reference (200). In one aspect of the invention, the time reference is contained in an integrated circuit package. In another aspect of the invention, the apparatus including the time reference are contained in an integrated circuit package.

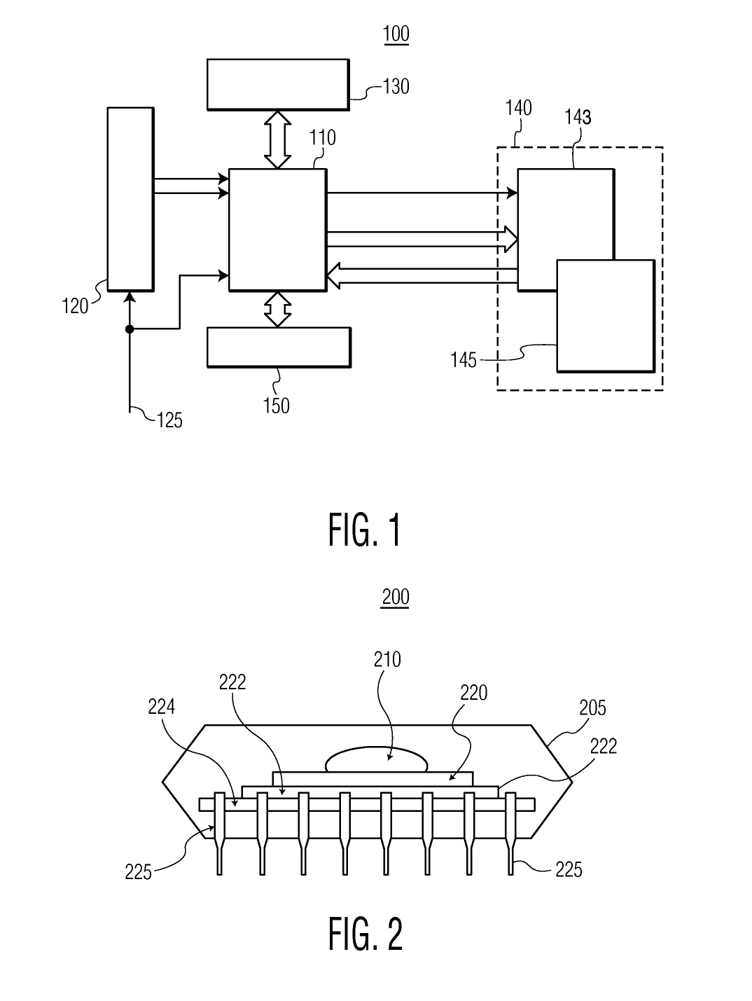

FIG. 1 illustrates a block diagram of a tamper-resistant time apparatus in accordance with the principles of the invention;

FIG. 2 illustrates a first exemplary embodiment of a tamper-resistant reference in accordance with the principles of the invention;

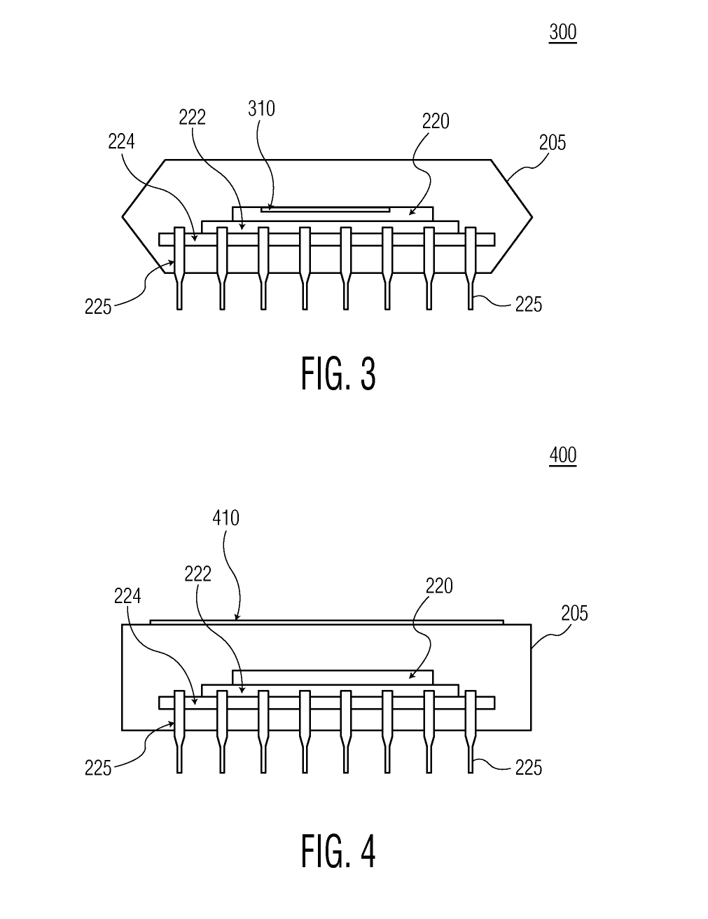

FIG. 3 illustrates a second exemplary embodiment of a tamper-resistant reference in accordance with the principles of the invention; and

FIG. 4 illustrates a third exemplary embodiment of a tamper-resistant reference in accordance with the principles of the invention.

It is to be understood that these drawings are solely for purposes of illustrating the concepts of the invention and are not intended as a definition of the limits of the invention. The embodiments shown in the figures herein and described in the accompanying detailed description are to be used as illustrative embodiments and should not be construed as the only manner of practicing the invention. Also, the same reference numerals, possibly supplemented with reference characters where appropriate, have been used to identify similar elements.

FIG. 1 illustrates a block diagram of a tamper-resistant time apparatus 100 in accordance with the principles of the invention. In this illustrative embodiment, central control unit 110 receives a clock reference from clock reference 120. As shown, clock reference 120 is an internal time reference. However an external clock reference 125, e.g., coming from a quartz crystal reference oscillator, may be inputted to control unit 110. In this case, the function of the internal timing reference unit 120 operates to verify that the external reference clock 125 has not been tampered with. This verification step is advantageous to prevent compromising the tamper-proof time reference by providing false external reference clock signals 125.

Control unit 110 is in communication with a non-volatile local-storage medium 130, which is used to store an initial time value, as it will be more fully explained. Control unit 110 is further in communication with a non-tamperable reference 140, which includes radiation sensor 143 containing radiating material 145.

Control unit 110 is further in communication with a host interface 150 that provides the communication means to a host system (not shown) and allows commands to be received and corresponding processing to be executed by control unit 110. Host interface 150 may provide commands such as “initialize” and “read.” In one aspect of the invention, the elements shown in FIG. 1 may be incorporated into an integrated circuit package.

In accordance with the principles of the invention, the non-tamperable reference 140 is associated with the decay of an associated radiation of a radioactive material that is difficult to manipulate. More specifically, the laws that describe the decay process of radioactive materials are well-known in the field of physics. The number of radioactive particles left at a fixed time after an initial point in time may be determined as:

N(t)=N₀exp(−(t−t₀)/t_{c}) [1]

where:
t_{c} is a time constant characterizing the rate of decay of the material; and
N₀ is the number of particles at time t₀.

The level of radiation at two points in time may be determined from equation 1 as:

t₂−t₁=t_{c} ln(N₁(t₁)/N₂(t₂)). [2]

Hence, in accordance with equation 2, a measure of the time elapsed from a first measurement may be determined without specific knowledge of the initial number of particles N₀. The level of radiation of a radioactive material is directly proportionate to the number of remaining radioactive particles. Hence, in accordance with the principles of the invention, in order to determine the number of remaining radioactive particles it is sufficient to measure the level of radiation. And an elapsed time may be determined from two contiguous measurements.

In one aspect of the invention, a radiation sensor includes a radiation counter based on a Dynamic Random Access Memory (DRAM) array. In order for this memory array to operate as a radiation counter, all storage elements, e.g., capacitors, are charged to substantially the same voltage value before an actual measurement occurs. Once the capacitors have reached substantially the same value, a measurement period begins. During the period of measurement, the radiation from the radioactive material 145 is passed through the memory (capacitor) array and causes the voltage on some of the capacitors to reduce to a voltage much less than the initially-set voltage, thus effectively discharging the capacitor. In this case, the number of capacitors in the memory array having a reduced voltage at the end of the measurement period is proportionate to the length of the measurement and the level of radiation to which the memory array has been exposed. At the end of the measurement interval, the control processor 110 may read the contents of the memory as if the contents were all data and count how many capacitors have a value different from the initially-set values.

Having determined the level of radiation at each of a first and a second measurement interval, equation 2 may then be used to determine the difference in time to achieve measured levels of radiation for each of the two periods. Accordingly, a first measurement of the level of radiation may be taken and stored in response to an “initialize” command and a second measurement of the level of radiation may be taken at a subsequent time and a time difference may then be determined. The time difference determined based on the first and second measurements may then be compared to the allowed time for viewing and when the time difference exceeds the grant or license time, further access to the digital content is inhibited. In another aspect of the invention, a time reference may be stored and the determined elapsed time added to the stored time reference to obtain a time value that may be compared to an absolute time.

In another aspect of the invention, an absolute reference measurement may be taken and stored in non-volatile local storage media 130. Non-volatile storage media is known in the art as a storage media that maintains its contents even when no power supply is provided. This reference measurement may be taken at the end of a production process, for example, where the level of radiation activity is measured in a secure environment. The secure reference value may then be stored in a program-once type memory, i.e., non-volatile memory. Such memory, referred to a PROM, uses well-known fuse link-based technology. The reference measurement may be used by control unit 110 to compare any reading or measurement generated. This may be advantageous when a reading is generated that is inconsistent with the stored measurement. In such cases, the control unit may generate a special indication to indicate such inconsistency.

FIG. 2 illustrates a cross-sectional view of a first exemplary embodiment of a DRAM-based sensor 200 in accordance with the principles of the present invention. In this exemplary first embodiment, contained within a conventional integrated packaging material 205 is radiation material 210, which is applied to time reference circuit 220. Material 210 may be applied to circuit 220 using materials such as a radioactive paint, tar or glue. Time reference circuit 220 is then, using conventional integrated circuit technology, applied to, or formed in a substrate mounting material 222. The substrate mounting material is applied to a lead frame 224 that contains integrated circuit pins 225. Hence, access to time reference circuit 220 is provided by integrated circuit pins 225, which are well-known in the field of integrated circuits and need not be discussed in detail herein. As one skilled in the art would recognize, the time reference 220 and the integrated circuit pins 225 may be connected using well-known bonding methods, which need not be discussed in detail herein.

FIG. 3 illustrates a cross-sectional view of a second exemplary embodiment of a DRAM-based sensor 300 in accordance with the principles of the present invention. In this exemplary second embodiment, radiation material 310 is integrated into an upper layer of time reference circuit 220. As previously discussed, access to time reference circuit 220 is provided by integrated circuit pins 225.

FIG. 4 illustrates a cross-sectional view of a third exemplary embodiment of a DRAM-based sensor 400 in accordance with the principles of the present invention. In this exemplary third embodiment, radiation material 410 is incorporated onto the packaging of the integrated circuit containing time reference circuit 220. Access to time reference circuit is via pins 225, as previously discussed.

As used herein, the control unit or processors (110) may be any means, such as a general-purpose or special-purpose system, or they may be a hardware configuration, such as a laptop computer, desktop computer, a server, hand-held computer, dedicated logic circuit, or integrated circuit. Preferably, processor 110 is selected from a group of Programmable Array Logic (PAL), Application Specific Integrated Circuit (ASIC), etc., which may be hardware “programmed” to include software instructions or a code that provides a known output in response to known inputs. In one aspect, hardware circuitry may be used in place of, or in combination with, software instructions to implement the invention. The elements illustrated herein may also be implemented as discrete hardware elements that are operable to perform the operations shown using coded logical operations or by executing a hardware-executable code. Memories may be any semiconductor memory, such as PROM, EPROM, EEPROM or RAM, that is external to processor 110 and/or may be integrated with a processor, e.g., a cache.

In one aspect, the principles of the present invention may be implemented by a computer-readable code executed by processor 110. The code may be stored in the memory or read/downloaded from a memory medium, an I/O device or magnetic, or optical media such as a floppy disk, a CD-ROM or a DVD, which are not shown.

While there has been shown, described, and noted fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. For example, while the present invention has been discussed with regard to the time allowed to view digital content, however, the present invention is also applicable to fields such as software licensing, access control billing, royalty payments, etc., where secure time references are needed. Furthermore, although the concepts are presented with regard to a DRAM-based sensor, it would be recognized that the radiation sensor may be based on a photo diode array technology. In addition, while the present invention has been shown with regard to an integrated circuit sensor, it would be recognized that when the sensor is used in an integrated circuit apparatus (FIG. 1), the contacts 225 may be integrated within the integrated circuit package. However, it is within the scope of the invention to construct a time reference using individual components that are contained in a tamper-resistant packaging.

Accordingly, it is expressly intended that all combinations of those elements that perform substantially the same function in substantially the same way to achieve the same results are within the scope of the invention. Substitutions of elements from one described embodiment to another are also fully intended and contemplated.

1. A tamper resistant sensor reference packaged in an integrated circuit, the sensor reference comprising: a radioactive material; a measurement circuit in contact with the radioactive material, the measure circuit for collecting for a predetermined period radiation generated by the radioactive material; and a plurality of contacts extending from the integrated circuit package for obtaining information from or providing information to the measurement circuit.

2. The time reference recited in claim 1, wherein the radioactive material is attached to the measurement circuit by a material selected from the group consisting of paint, glue, and tar.

3. The sensor reference recited in claim 1, wherein the radioactive material is integrated into the measurement circuit.

4. The sensor reference recited in claim 1, wherein the radioactive material is integrated into the integrated circuit package.

5. The sensor reference recited in claim 1, further comprising means for responding to a command to initiate a measurement, wherein said measurement period is predetermined.

6. The sensor reference recited in claim 1, further comprising means for establishing an initial state of the measurement circuit in response to an “initiate” command.

7. The sensor reference recited in claim 1, wherein said measurement circuit is selected from the group consisting of DRAM and photo diode array.

8. An integrated circuit for obtaining tamper-resistant time measurement comprising a sensor reference comprising: a radioactive material; a measurement circuit in contact with the radioactive material, the measure circuit for collecting for a predetermined period radiation generated by the radioactive material; and a processor in communication with the sensor reference, the processor providing a command for initiating a measurement by the sensor reference and for determining an elapsed time based on a plurality of measurements by the time reference.

9. The circuit as recited in claim 8, further comprising: an internal timing reference in communication with the processor.

10. The circuit as recited in claim 8, wherein said internal timing reference further comprising: receiving means for receiving a signal from an external clock reference.

11. The circuit as recited in claim 10, wherein said internal timing reference further comprising: means for comparing a signal provided by the internal timing reference with the signal provided by the external clock reference.

12. The circuit as recited in claim 8, said processor further comprising: receiving means for receiving a signal from an external clock reference; and means for storing the external clock reference signal in a memory.

13. The circuit as recited in claim 12, wherein said processor further comprising: means for comparing the stored external clock reference signal and the determined elapsed time to a predetermined value.

14. The circuit as recited in claim 8, wherein said processor further comprising: means for comparing the determined elapsed time to a predetermined value.

15. The circuit as recited in claim 8, further comprising: a non-volatile memory in communication with the processor.

16. The circuit as recited in claim 8, further comprising an interface in communication with the processor, said interface providing means to communicate with said processor and receiving commands.

17. A time measurement circuit contained in a tamper-resistant package, said circuit comprising: a sensor reference comprising: a radioactive material; a measurement circuit in contact with the radioactive materialism, the measurement circuit for collecting for a predetermined period radiation generated by the radioactive material; a processor in communication with the sensor reference, the processor providing a command for initiating a measurement by the sensor reference and for determining an elapsed time based on a plurality of measurements by the time referenced; an internal timing reference in communication with the processor containing receiving means for receiving a signal from an external clock reference.

18. The circuit as recited in claim 17, wherein said internal timing reference further comprising: means for comparing a signal provided by the internal timing reference with the signal provided by the external clock reference.

19. The circuit as recited in claim 17, said processor further comprising: receiving means for receiving a signal from an external clock reference; and means for storing the external clock reference signal in a memory.

20. The circuit as recited in claim 17, wherein said processor further comprising: means for comparing the stored external clock reference signal and the determined elapsed time to a predetermined value.

21. The circuit as recited in claim 17, wherein said processor further comprising: means for comparing the determined elapsed time to a predetermined value.

22. The circuit as recited in claim 17, further comprising a non-volatile memory in communication with the processor.

23. The circuit as recited in claim 17, further comprising an interface in communication with the processor, said interface providing means to communicate with said processor and for receiving said commands.
